(19) United States
(12) Patent Application Publication
(10) Pub. No.: US 2020/0164522 A1
(43) Pub. Date: May 28, 2020

(54) MOBILE TERMINAL AND MUSIC PLAY-BACK SYSTEM COMPRISING MOBILE TERMINAL

(71) Applicant: LG ELECTRONICS INC., Seoul (KR)

(72) Inventors: Jinho SOHN, Seoul (KR); Sanghun KIM, Seoul (KR); Sangmin LEE, Seoul (KR); Wonhee LEE, Seoul (KR); Sewan GU, Seoul (KR); Kyoungup PARK, Seoul (KR)

(21) Appl. No.: 16/633,853

(22) PCT Filed: Sep. 19, 2018
(86) PCT No.: PCT/KR2018/011019

§ 371 Date: Jan. 24, 2020

Related U.S. Application Data
(60) Provisional application No. 62/590,669, filed on Nov. 27, 2017.

(30) Foreign Application Priority Data
Apr. 20, 2018 (KR) 10-2018-0046102

(51) Int. Cl. B25J 13/00; G10H 1/00

(52) U.S. Cl. CPC B25J 13/003; G10H 1/0008; G10H 1/0083

(57) ABSTRACT

A mobile terminal includes a display, a communicator configured to perform communication with a plurality of music bots, and a controller configured to extract sound source characteristic information from each of a plurality of previously divided sound source tracks configuring music, generate a plurality of control commands for controlling operation of the plurality of music bots using the extracted sound source characteristic information, and transmit each of the plurality of generated control commands to each of the plurality of music bots through the communicator.

### TECHNICAL FIELD

The present disclosure relates to a mobile terminal and a music playback system including the mobile terminal.

### BACKGROUND ART

With development of robot technology, methods of building a robot by modularizing joints or wheels have been used. For example, a plurality of actuator modules configuring the robot are electrically and mechanically connected and assembled, thereby making various types of robots such as dogs, dinosaurs, humans or spiders.

A robot which may be manufactured by assembling a plurality of actuators modules may be referred to as a modular robot. Each actuator module configuring the modular robot is provided with a motor therein, thereby performing a motion of the robot according to rotation of the motor. The motion of the robot includes movement of the robot such as movement and dancing.

Recently, as entertainment robots have appeared, interest in robots for encouraging entertainment or arousing human interest is increasing. For example, techniques of allowing robots to dance to music have been developed.

The robots may dance by setting a plurality of motions suitable for a sound source in advance and performing the set motions when an external device plays a sound source back.

However, conventionally, it is difficult to synchronize a point in time of starting the dance to the played music and it is difficult to allow the dance to harmonize with music.

In addition, conventionally, a robot for receiving music, analyzing parameters for a dance motion, generating dance motion information prestored based on the analyzed parameters, and dancing to music has been proposed. The robot has a difficulty in analyzing the received music.

### DISCLOSURE

### Technical Problem

An object of the present disclosure is to provide a mobile terminal capable of mapping a plurality of music bots to a plurality of sound source tracks configuring one music to take action corresponding to the sound source track, and a music playback system including the same.

### Technical Solution

A mobile terminal according to an embodiment may include a display, a communicator configured to perform communication with a plurality of music bots; and a controller configured to extract sound source characteristic information from each of a plurality of previously divided sound source tracks configuring music, generate a plurality of control commands for controlling operation of the plurality of music bots using the extracted sound source characteristic information, and transmit each of the plurality of generated control commands to each of the plurality of music bots through the communicator.

The sound source characteristic information may include onset position information of a point in time when a sound source track starts, beat position information of a beat of the sound source track, segment time information of a point in time when an atmosphere of the sound source track is changed, and tempo information of a speed of the sound source track.

The onset position information may include information on a timing when hand motion of a music bot is controlled, the beat position information may include information on a timing when head motion of the music bot is controlled, the segment time information may include information on a timing when the music bot is rotated, and the tempo information may include information on a repetition period of the hand motion, head motion and rotation motion of the music bot.

The controller may generate segment information including a rotation angle and a rotation maintaining time of the music robot based on the segment time information and include and transmit the generated segment information in the control command

The mobile terminal may further include a memory configured to store a plurality of pieces of sound source characteristic information, and each of the plurality of pieces of sound source characteristic information is stored in a state of being mapped to each of the plurality of music bots.

The controller may transmit each of the plurality of sound source tracks to each of the plurality of music bots along with each of the plurality of control commands.

The display may display a plurality of buttons respectively mapped to the plurality of music bots, and the controller may transmit the control command to a music bot corresponding to one or more buttons selected from among the plurality of buttons.

The communicator may transmit the control command using a universal serial bus (USB) standard.

A music playback system according to an embodiment includes a plurality of music bots configured to output a sound source track, and a mobile terminal configured to extract sound source characteristic information from each of a plurality of previously divided sound source tracks configuring music, generate a plurality of control commands for controlling operation of the plurality of music bots using the extracted sound source characteristic information, and transmit each of the plurality of generated control commands to each of the plurality of music bots through a communicator.

### Advantageous Effects

When divided sound source tracks are simultaneously played back through a speaker included in a music bot, a user may feel that each music bot is actually playing its part.

In addition, a space sense similar to a live performance may be formed according to arrangement of music bots.

### DESCRIPTION OF DRAWINGS

FIGS. 1 to 3 are views illustrating the configuration of a music playback system according to an embodiment.

FIG. 4 is a block diagram of a mobile terminal configuring the music playback system according to an embodiment.

FIG. 5 is a flowchart illustrating a method of operating a mobile terminal according to an embodiment.

FIGS. 6 and 7 are views illustrating a process of extracting sound source characteristic information from each sound source track according to an embodiment.

FIG. 8 is a view illustrating sound source analysis information according to an embodiment.

FIG. 9 is a view illustrating a control screen for controlling operations of a plurality of music bots according to an embodiment.

### BEST MODE

Description will now be given in detail according to exemplary embodiments disclosed herein, with reference to the accompanying drawings. The suffixes “module” and “unit” of elements herein are used for convenience of description and thus can be used interchangeably and do not have any distinguishable meanings or functions.

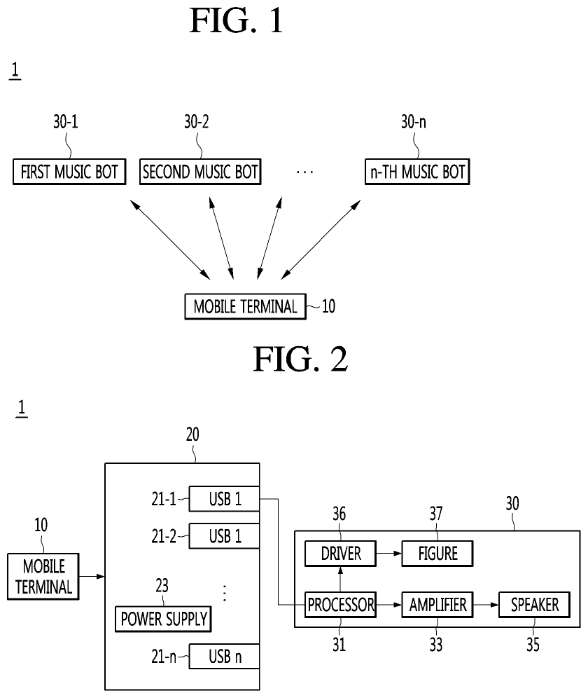

FIGS. 1 to 3 are views illustrating the configuration of a music playback system according to an embodiment.

First, referring to FIG. 1, the music playback system 1 according to the embodiment may include a mobile terminal 10 and a plurality of music robots 30-1 to 30-n.

The mobile terminal 10 may perform communication with the plurality of music bots 30-1 to 30-n.

The mobile terminal 10 may transmit a control signal to each of the plurality of music bots 30-1 to 30-n by wires or wirelessly.

In one embodiment, the mobile terminal 10 may transmit the control command to each music bot 30 using the universal serial bus (USB) standard, when wired communication is used.

In another embodiment, the mobile terminal 10 may transmit the control command to each music bot 30 using the short range wireless communication standard, when wireless communication is used.

The short range wireless communication standard may be any one of Bluetooth, ZigBee, Wi-Fi, but this is merely an example.

Each of the plurality of music bots 30-1 to 30-n may play each of a plurality of sound sources configuring one music according to the control command received from the mobile terminal 10.

In addition, each of the plurality of music bots 30-1 to 30-n may perform a specific motion while playing back the sound source corresponding thereto.

Referring to FIG. 2, the music playback system 1 may further include a wired interface 20 in addition to the mobile terminal 10 and the music bot 30.

Particularly, FIG. 2 is a view illustrating an example in which the mobile terminal 10 controls operation of the music bot 30 through wired communication.

The wired interface 20 may transmit the control command received from the mobile terminal 10 and the sound source to the music bot 30.

The wired interface 20 may include a plurality of USB ports 21-1 to 21-n and a power supply 23.

Each of the plurality of USB ports 21-1 to 21-n may be connected to each of the plurality of music bots to transmit the control command received from the mobile terminal 10 to each music bot.

The power supply 23 may supply power to each music bot.

The music bot 30 may include a processor 31, an amplifier 33, a speaker 35, a driver 36 and a FIG. 37.

The processor 31 may control overall operation of the music bot 30.

The processor 31 may receive, from the mobile terminal 10, a specific sound source track among a plurality of sound source tracks configuring one music.

The processor 31 may transmit the received sound source track to the amplifier 33.

The amplifier 33 may amplify the received sound source track.

The speaker 35 may output the amplified sound source track. Although the speaker 35 is described as being included in the music bot 30 in FIG. 2, this is merely an example and the speaker may be configured independently of the music bot 30.

The driver 36 may operate the FIG. 37 according to a driving command received from the processor 31.

The driver 36 may control operation of the FIG. 37 to take a specific motion according to the driving command received from the processor 31.

The FIG. 37 may perform the specific motion according to the driving command received from the driver 36.

The FIG. 37 may be disposed on the upper end of the speaker 35, but this is merely an example.

FIG. 3 is a view showing an actual example of the music bot 30.

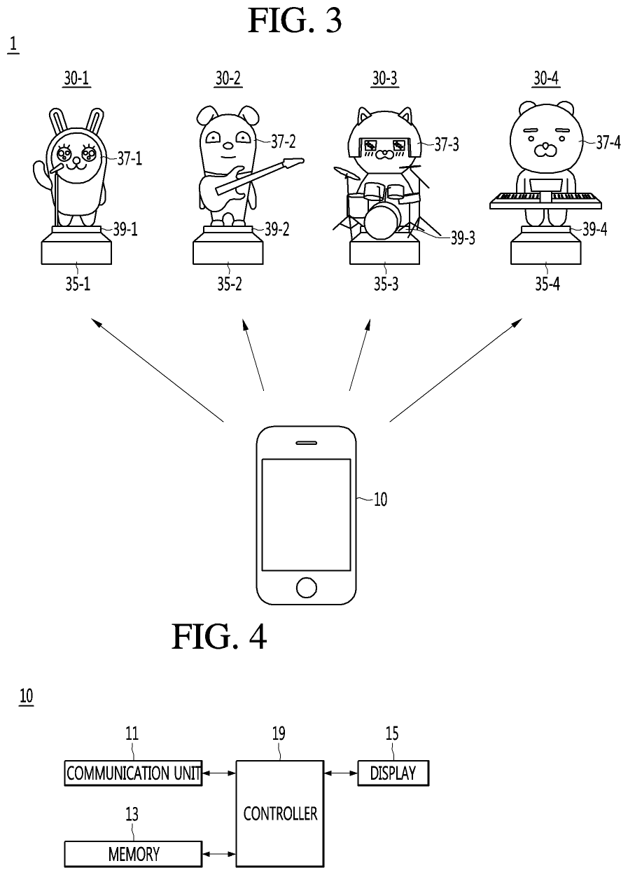

Although it is assumed that the number of music bots 30 is 4 in FIG. 4, this is merely an example.

One music may include a plurality of sound source tracks. For example, one music may include a vocal sound source track, a guitar sound source track, a drum sound source track and a keyboard sound source track.

In the following embodiment, it is assumed that that one music includes a vocal sound source track, a guitar sound source track, a drum sound source track and a keyboard sound source track.

The mobile terminal 10 may transmit each of a plurality of previously divided sound source tracks to each of the plurality of music bots 30-1 to 30-4.

The first music bot 30-1 includes a first speaker 35-1 and a first FIG. 37-1.

The mobile terminal 10 may transmit the vocal sound source track to the first music bot 30-1, and the first speaker 35-1 may output the vocal sound source track received from the mobile terminal 10.

The first FIG. 37-1 may have a shape corresponding to the vocal sound source track.

A first rotation plate 3901 capable of rotating the first FIG. 37-1 may be further provided on the lower end of the first FIG. 37-1.

The first FIG. 37-1 may be driven according to the vocal sound source track output by the first speaker 35-1.

For example, the first FIG. 37-1 may take a motion to grip a microphone and sing a song according to the vocal sound source track.

The second music bot 30-2 includes a second speaker 35-2 and a second FIG. 37-2.

The mobile terminal 10 may transmit the guitar sound source track to the second music bot 30-2, and the second speaker 35-2 may output the received guitar sound source track.

The second FIG. 37-1 may have a shape corresponding to the guitar sound source track.

A second rotation plate 39-2 capable of rotating the second FIG. 37-2 may be further provided on the lower end of the second FIG. 37-2.

The second FIG. 37-2 may be driven according to the guitar sound source track output by the second speaker 35-2. For example, the second FIG. 37-2 may take a motion to play the guitar according to the guitar sound source track.

The third music bot 30-3 includes a third speaker 35-3 and a third FIG. 37-3.

The mobile terminal 10 may transmit the drum sound source track to the third music bot 30-3, and the third speaker 35-3 may output the received drum sound source track.

The third FIG. 37-3 may have a shape corresponding to the drum sound source track.

A third rotation plate 39-3 capable of rotating the third FIG. 37-3 may be further provided on the lower end of the third FIG. 37-3.

The third FIG. 37-3 may be driven according to the drum sound source track output by the third speaker 35-3. For example, the third FIG. 37-3 may take a motion to play the drum according to the drum sound source track.

The fourth music bot 30-4 includes a fourth speaker 35-4 and a fourth FIG. 37-4.

The mobile terminal 10 may transmit the keyboard sound source track to the fourth music bot 30-4, and the fourth speaker 35-4 may output the received keyboard sound source track.

The fourth FIG. 37-4 may have a shape corresponding to the keyboard sound source track.

A fourth rotation plate 39-4 capable of rotating the fourth FIG. 37-4 may be further provided on the lower end of the fourth FIG. 37-4.

The fourth FIG. 37-4 may be driven according to the keyboard sound source track output by the fourth speaker 35-4. For example, the fourth FIG. 37-4 may take a motion to hit the notes according to the keyboard sound source track.

Next, FIG. 4 will be described.

FIG. 4 is a block diagram of a mobile terminal configuring the music playback system according to an embodiment.

Referring to FIG. 4, the mobile terminal 10 may include a communication unit 11, a memory 13, a display 15 and a controller 19.

The communication unit 11 may perform wired or wireless communication with the music bot 30.

When the communication unit 11 performs wired communication with the music bot 30, the USB standard may be used as the wired communication standard.

When the communication unit 11 performs wireless communication with the music bot 30, the short range wireless communication standard such as Bluetooth, ZigBee or Wi-Fi may be used as the short range wireless communication standard.

The communication unit 11 may transmit a plurality of control commands generated by the controller 19 to the plurality of music bots, respectively.

The memory 13 stores a plurality of pieces of sound source characteristic information respectively extracted from the plurality of sound source tracks.

The sound source characteristic information may include onset position information, beat position information, tempo information and segment time information.

The memory 13 may store the plurality of sound source tracks in correspondence with the plurality of pieces of sound source characteristic information.

The display 15 may display a control screen for controlling the plurality of music bots 30-1 to 30-n.

The display 15 may be configured in the form of a touchscreen capable of enabling a user to perform touch input.

The controller 19 may control overall operation of the mobile terminal 10.

The controller 19 may acquire the plurality of sound source tracks configuring one music.

The controller 19 may extract sound source characteristic information from each of the plurality of acquired sound source tracks.

The controller 19 may generate a plurality of control commands for controlling operation of the plurality of music bots 30-1 to 30-n using the extracted sound source characteristic information.

The controller 19 may transmit each of the plurality of generated control commands to each of the plurality of music bots 30-1 to 30-n.

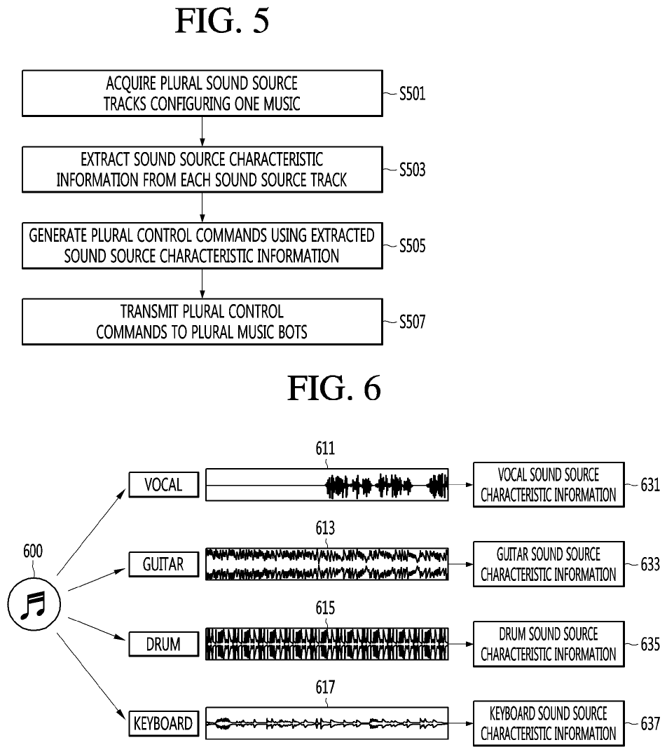

Next, a method of operating a mobile terminal according to an embodiment will be described with reference to FIG. 5.

FIG. 5 is a flowchart illustrating a method of operating a mobile terminal according to an embodiment.

Hereinafter, the method of operating the mobile terminal 10 according to the embodiment will be described in association with FIGS. 1 to 4.

Referring to FIG. 5, the controller 19 of the mobile terminal 10 acquires the plurality of sound source tracks configuring one music (S501).

One music may include a plurality of sound source tracks. For example, one music may include a vocal sound source track, a guitar sound source track, a drum sound source track and a keyboard sound source track.

One music may be stored in the memory 13 in a state of being divided into the vocal sound source track, the guitar sound source track, the drum sound source track and the keyboard sound source track.

The controller 19 may acquire the plurality of divided sound source tracks from the memory 13.

The controller 19 extracts sound source characteristic information from each of the plurality of acquired sound source tracks (S503).

The sound source characteristic information extracted from each of the plurality of sound source tracks may be mapped to each of the plurality of music bots. The sound source characteristic information may be used to control operation of each music bot 30.

In one embodiment, the sound source characteristic information may include onset position information, beat position information, segment time information and tempo information.

The onset position information may be information on a point in time when a specific sound source track starts.

The onset position information may include a plurality of points in time when the specific sound source track starts.

The beat position information may be information on the beat of a specific sound source track.

The segment time information may be information on a point in time when the atmosphere of a specific sound source track is changed.

The tempo information may be information on the playback speed of a specific sound source track.

The controller 19 may extract the onset position information, the beat position information, the segment time information and the tempo information from each divided sound source track.

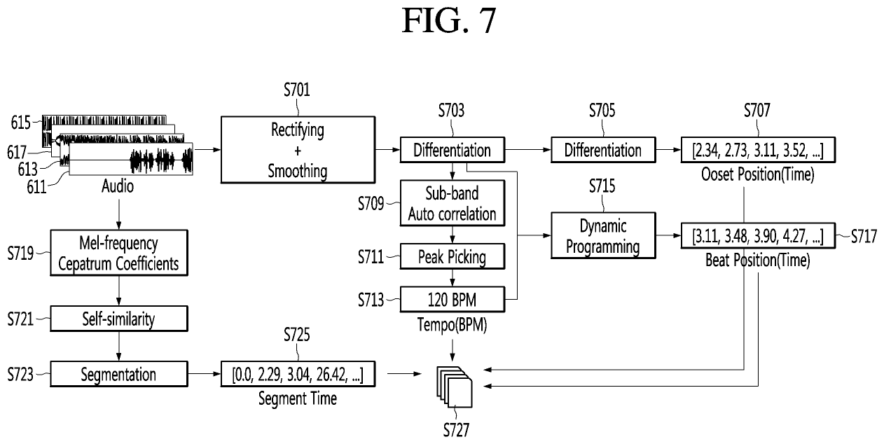

This will be described with reference to FIGS. 6 and 7.

FIGS. 6 and 7 are views illustrating a process of extracting sound source characteristic information from each sound source track according to an embodiment.

First, referring to FIG. 6, one music 600 may be divided into the plurality of sound source tracks 611 to 617 and stored in the memory 13.

Each of the plurality of sound source tracks 611 to 617 may be represented by a sound source signal changed during the playback period of the music 600.

The controller 19 may extract vocal sound source characteristic information 631 from the vocal sound source track 611.

The controller 19 may extract guitar sound source characteristic information 633 from the guitar sound source track 613.

The controller 19 may extract drum sound source characteristic information from the drum sound source track 615.

The controller 19 may extract keyboard sound source characteristic information 637 from the keyboard sound source track 617.

A process of extracting sound source characteristic information from each sound source track will be described in greater detail with reference to FIG. 7.

The controller 19 may extract sound source characteristic information from the plurality of sound source tracks 611 to 617 according to the flowchart shown in FIG. 7.

First, the controller 19 performs rectification and smoothing with respect to the sound source track (S701).

Thereafter, the controller 19 performs a differentiation process (S703).

The controller 19 performs peak picking to extract a peak value from the sound source track subjected to the differentiation process (S705).

The controller 19 acquires the onset position information of the sound source track as peak picking is performed (S707).

The onset position information may include points in time when the sound sources start.

For example, when the analyzed sound source track is a guitar sound source track, the onset position information of the guitar sound source track may include information on the point in time when the guitar sound source starts, such as [2.34, 2.73, 3.11, 3.52].

2.34 may means a point of 2 minutes and 34 seconds, when the total playback period of music is 5 minutes. Specifically, 2.34 seconds may be an operation timing when a figure's hand moves.

Meanwhile, the controller 19 performs a sub-band autocorrelation process after the differentiation process (S709).

The sub-band autocorrelation process may be a process of extracting periodicity of the sound source track signal.

The sub-band autocorrelation process may be a process of dividing a detection function into a plurality of sub-bands, applying a filter bank to each divided sub-band, and performing peak picking with respect to an entire tempo range.

The controller 19 performs peak picking to extract a peak value after the sub-band autocorrelation process (S711), and acquires the tempo information of the sound source track (S713).

For example, when the analyzed sound source track is a guitar sound source track, the tempo of the guitar sound source track may be 120 BPM.

Meanwhile, the controller 19 performs dynamic programming operation using the result of differentiating the specific sound source track and the acquired tempo information (S715).

The controller 19 acquires beat position information according to the dynamic programming operation (S717).

Meanwhile, the controller 19 extracts Mel-Frequency Cepstrum Coefficients from the specific sound source track (S719).

Thereafter, the controller 19 performs a self-similarity process (S721), performs segmentation process with respect to the result of performing the self-similarity process (S723), and acquires segment time information (S725).

The segment time information may include information on points in when the atmosphere of the specific sound source track is changed.

For example, when the analyzed sound source track is a guitar sound source track, the segment time information of the guitar sound source track may include information on points in time when the atmosphere of the guitar sound source is changed, such as [0.00, 2.29, 3.04, 26.42].

The controller 19 acquires the sound source characteristic information including the onset position information, the beat position information, the tempo information and the segment time information of each sound source track (S727).

FIG. 5 will be described again.

The controller 19 generates a plurality of control commands for controlling operation of the plurality of music bots 30-1 to 30-n using the extracted sound source characteristic information (S505).

Each of the plurality of control commands may be mapped to each of the plurality of music bots.

In one embodiment, the onset position information included in the sound source characteristic information may be used to control the hand motion of the FIG. 37 configuring the music bot 30.

The onset position information may include information on a timing when the hand motion of the music bot is controlled.

For example, the controller 19 may generate a hand control command for controlling the hand motion of the figure using the onset position information.

Specifically, when the onset position information of the guitar sound source track is [2.34, 2.73, 3.11, 3.52], a hand control command for moving the hand of the second FIG. 37-2 of the second music bot 30-2 may be generated at a corresponding point in time.

In one embodiment, the beat position information may be used to control the head motion of the FIG. 37 configuring the music bot 30.

The beat position information may include information on a timing when the head motion of the music bot is controlled.

For example, the controller 19 may generate a head control command for controlling the head motion of the figure using the beat position information. Specifically, when the beat position information of the guitar sound source track is [3.11, 3.48, 3.90, 4.27], the controller 19 may generate a head control command for moving the head of the second FIG. 37-2 of the second music bot 30-2 at a corresponding point in time.

In one embodiment, the tempo information may be used to control the rotation speed of the rotation plate configuring the music bot 30.

For example, the controller 19 may generate a rotation plate speed control information for controlling the rotation speed of the rotation plate supporting the figure, using the tempo information. Specifically, when the tempo information of the guitar sound source track is 120 BPM, the controller 19 may generate a rotation plate speed control command for controlling the speed of the rotation plate to the speed corresponding to the tempo.

In another embodiment, the tempo information may include information on the repetition period of hand motion, head motion and rotation motion of the figure.

In one embodiment, the segment time information may be used to change action taken by the figure configuring the music bot 30.

The segment time information may include information a timing when the music bot rotates.

For example, the controller 19 may generate a repeated action command for changing first action repeatedly taken by the figure to a repeated second action using the segment time information.

Specifically, when the segment time information of the guitar sound source track is [0.00, 2.29, 3.04, 26.42], the controller 19 may generate a repeated action control command for changing the action taken by the figure at a corresponding point in time.

The control command may include a plurality of motion control commands. The plurality of motion control commands may include a hand control command, a head control command, a repeated action control information and a rotation plate speed control command, as described above.

In addition, the controller 19 may store, in the memory 13, sound source analysis information obtained by combining the vocal sound source characteristic information, the guitar sound source characteristic information, the drum sound source characteristic information and the keyboard sound source characteristic information.

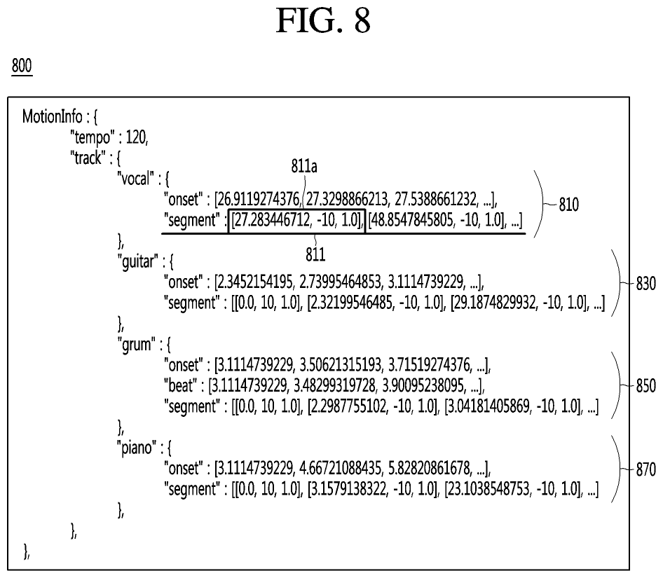

The sound source analysis information will be described with reference to FIG. 8.

FIG. 8 is a view illustrating sound source analysis information according to an embodiment.

Referring to FIG. 8, the sound source analysis information may include vocal sound source characteristic information 810, guitar sound source characteristic information 830, drum sound source characteristic information 850 and keyboard sound source characteristic information 870.

The tempo information 890 of the sound source characteristic information is commonly 120 BPM.

Each of the vocal sound source characteristic information 810, the guitar sound source characteristic information 830, the keyboard sound source characteristic information 870 may include onset position information and segment information.

In one embodiment, the segment information may be generated based on the segment time information. The segment time information may include a plurality of points in time in which the atmosphere of the sound source track is changed.

The segment information may include a segment item including any one of a plurality of points in time, a rotation angle of a rotation plate supporting a figure and a time when rotation is maintained.

That is, the segment information may include a plurality of segment items.

Referring to FIG. 8, the segment item 811a of the segment information 811 included in the vocal sound source characteristic information 810 is configured as [27.283446712, −10, 1.0].

Here, 27.283446712 may be a point in time when the rotation plate rotates in the total playback period of music, −10 may be the rotation angle of the rotation plate, and 1.0 may be a time when rotation at −10 degrees is maintained.

The controller 19 may include the sound source characteristic information in the control command and transmit the sound source characteristic information to the music bot.

The drum sound source characteristic information 850 may include onset position information, beat position information and segment information.

FIG. 5 will be described.

The controller 19 transmits each of the plurality of generated control commands to each of the plurality of music bots 30-1 to 30-n (S507).

The controller 19 may transmit the control command to each music bot through the communication unit 11.

For example, the controller 19 may transmit a first control command to the first music bot 30-1, transmit a second control command to the second music bot 30-2, transmit a third control command to the third music bot 30-3, and transmit a fourth control command to the fourth music bot 30-4.

The first control command may control the motion of the first music bot 30-1 based on the vocal sound source characteristic information 810. The first music bot 30-1 may take a motion corresponding to a specific point in time according to the vocal sound source characteristic information 810 corresponding to the first control command received from the mobile terminal 10.

The second control command may control the motion of the second music bot 30-2 based on the guitar sound source characteristic information 830. The second music bot 30-2 may take a motion corresponding to a specific point in time according to the guitar sound source characteristic information 830 corresponding to the second control command received from the mobile terminal 10.

The third control command may control the motion of the third music bot 30-3 based on the drum sound source characteristic information 850. The third music bot 30-3 may take a motion corresponding to a specific point in according to the drum sound source characteristic information 850 corresponding to the third control command received from the mobile terminal 10.

The fourth control command may control the motion of the fourth music bot 30-4 based on the keyboard sound source characteristic information 870. The fourth music bot 30-4 may take a motion corresponding to a specific point in time according to the keyboard sound source characteristic information 870 corresponding to the fourth control command received from the mobile terminal 10.

The first to fourth music bots 30-1 to 30-4 may operate in synchronization with the received control commands.

That is, as one music is played back, the music robot responsible for one sound source track takes a motion reflecting the characteristics of the sound source track in real time, thereby enabling emotional interaction with the user.

When the user simultaneously plays the divided sound source tracks through the speakers respectively included in music bots, the user may feel that each music bot actually plays each part.

In addition, to space sense similar to a live performance may be formed according to arrangement of the music bots.

In addition, while the controller 19 transmits a control command to each music bot, the controller 19 may also transmit the sound source track matching each music bot.

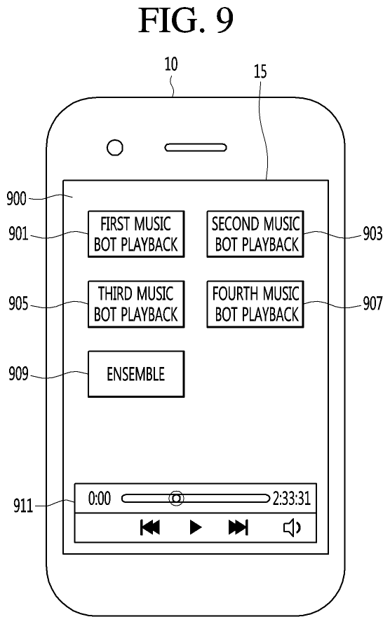

FIG. 9 is a view illustrating a control screen for controlling operations of a plurality of music bots according to an embodiment.

Referring to FIG. 9, the display 15 of the mobile terminal 10 may display a control screen 900 for controlling operation of the plurality of music robots 30-1 to 30-4 according to execution of an application.

The control screen may include a first button 901 for controlling operation of the first music bot 30-1, a second button 903 for controlling operation of the second music bot 30-2, a third button 905 for controlling operation of the third music bot 30-3, and a fourth button 907 for controlling operation of the fourth music bot 30-4.

For example, when the first button 901 is selected, the mobile terminal 10 may transmit a control command for controlling the output of the vocal sound source track and the motion of the FIG. 37-1 of the first music bot 30-1 to the first music bot 30-1.

The control screen 900 may further include a fifth button 909 for allowing the first to fourth music bots 30-1 to 30-4 to perform an ensemble.

When the fifth button 909 is selected, the controller 19 may transmit, to the first to fourth music bots 30-1 to 30-4, a control command for allowing the first to fourth music bots 30-1 to 30-4 to take specific motions according to the sound source characteristic information while outputting the sound source tracks.

The control screen 900 may further include a playback bar 911 indicating the playback state of music.

Selection of the playback button included in the playback bar 911 may be treated equally with selection of the fifth button 909.

Meanwhile, the user may selectively press one or more of the first to fourth buttons 901 to 907.

Therefore, the mobile terminal 10 may transmit a control command to one or more music bots corresponding to the selected one or more buttons. For example, when the user wants to listen to only the vocal sound source track and the guitar sound source track, only the first button 901 and the second button 903 may be selected.

The present disclosure mentioned in the foregoing description can also be embodied as processor readable codes on a processor-readable recording medium. Examples of possible computer-readable mediums include read-only memories (ROMs), random-access memories (RAMs), CD-ROMs, magnetic tapes, floppy disks, optical data storage devices, and carrier waves (such as data transmission through the Internet).

The above-described display device is not limited to the configuration and method of the above-described embodiments, but the embodiments may be variously modified by selectively combining all or some of the embodiments.

1. A mobile terminal comprising:
a display;
a communicator configured to perform communication with a plurality of music bots; and
a controller configured to:
extract sound source characteristic information from each of a plurality of previously divided sound source tracks configuring music,
generate a plurality of control commands for controlling operation of the plurality of music bots using the extracted sound source characteristic information, and
transmit each of the plurality of generated control commands to each of the plurality of music bots through the communicator.

2. The mobile terminal according to claim 1, wherein the sound source characteristic information includes onset position information of a point in time when a sound source track starts, beat position information of a beat of the sound source track, segment time information of a point in time when an atmosphere of the sound source track is changed, and tempo information of a speed of the sound source track.

3. The mobile terminal according to claim 2,
wherein the onset position information includes information on a timing when hand motion of a music bot is controlled,
wherein the beat position information includes information on a timing when head motion of the music bot is controlled,
wherein the segment time information includes information on a timing when the music bot is rotated, and
wherein the tempo information includes information on a repetition period of the hand motion, head motion and rotation motion of the music bot.

4. The mobile terminal according to claim 3, wherein the controller generates segment information including a rotation angle and a rotation maintaining time of the music robot based on the segment time information and includes and transmits the generated segment information in the control command.

5. The mobile terminal according to claim 3, further comprising a memory configured to store a plurality of pieces of sound source characteristic information,
wherein each of the plurality of pieces of sound source characteristic information is stored in a state of being mapped to each of the plurality of music bots.

6. The mobile terminal according to claim 1, wherein the controller transmits each of the plurality of sound source tracks to each of the plurality of music bots along with each of the plurality of control commands.

7. The mobile terminal according to claim 1,
wherein the display displays a plurality of buttons respectively mapped to the plurality of music bots, and
wherein the controller transmits the control command to a music bot corresponding to one or more buttons selected from among the plurality of buttons.

8. The mobile terminal according to claim 1, wherein the communicator transmits the control command using a universal serial bus (USB) standard.

9. A music playback system comprising:
a plurality of music bots configured to output a sound source track; and
a mobile terminal configured to:
extract sound source characteristic information from each of a plurality of previously divided sound source tracks configuring music,
generate a plurality of control commands for controlling operation of the plurality of music bots using the extracted sound source characteristic information, and
transmit each of the plurality of generated control commands to each of the plurality of music bots through a communicator.

10. The music playback system according to claim 9, wherein the sound source characteristic information includes onset position information of a point in time when a sound source track starts, beat position information of a beat of the sound source track, segment time information of a point in time when an atmosphere of the sound source track is changed, and tempo information of a speed of the sound source track.

11. The music playback system according to claim 10,
wherein the onset position information includes information on a timing when hand motion of a music bot is controlled,
wherein the beat position information includes information on a timing when head motion of the music bot is controlled,
wherein the segment time information includes information on a timing when the music bot is rotated, and
wherein the tempo information includes information on a repetition period of the hand motion, head motion and rotation motion of the music bot.

12. The music playback system according to claim 11, wherein the mobile terminal generates segment information including an a rotation angle and a rotation maintaining time of the music robot based on the segment time information and includes and transmits the generated segment information in the control command.

13. The music playback system according to claim 9,
wherein the mobile terminal further includes a memory configured to store a plurality of pieces of sound source characteristic information,
wherein each of the plurality of pieces of sound source characteristic information is stored in a state of being mapped to each of the plurality of music bots.

14. The music playback system according to claim 9, wherein the mobile terminal transmits each of the plurality of sound source tracks to each of the plurality of music bots along with each of the plurality of control commands.

15. The music playback system according to claim 9,
wherein the mobile terminal includes a display configured to display a plurality of buttons respectively mapped to the plurality of music bots, and
wherein the mobile terminal transmits the control command to a music bot corresponding to one or more buttons selected from among the plurality of buttons.
